(19) United States
(12) Patent Application Publication
(10) Pub. No.: US 2004/0125731 A1
(43) Pub. Date: Jul. 1, 2004

(54) High-density optical disc, and apparatus and method for reproducing/recording data thereon

(76) Inventor: Kyung Chan Park, Seoul (KR)

Correspondence Address: HARNESS, DICKEY & PIERCE, P.L.C., P.O. BOX 8910, RESTON, VA, 20195, US

(21) Appl. No.: 10/659,388

(22) Filed: Sep. 11, 2003

(30) Foreign Application Priority Data
Sep. 12, 2002 (KR) 10-2002-0055471

(51) Int. Cl. G11B 7/0045; G11B 7/24

(52) U.S. Cl. 369/59.25; 369/275.3

(57) ABSTRACT

Disclosed are a high-density optical disc, and an apparatus and method for reproducing/recording data stored in the high-density optical disc. Data is recorded in a Lead-In area of the high-density optical disc in the form of straight pre-pits associated with HFM (High Frequency Modulated) grooves in order for the same tracking servo operation to be successively performed over the whole area of a single high-density optical disc, such that it can efficiently prevent an algorithm for controlling a plurality of tracking servo units and an apparatus for implementing the algorithm from being undesirably complicated.

### BACKGROUND OF THE INVENTION

1. Field of the Invention

The present invention relates to a high-density optical disc such as a Blu-ray disc capable of storing large amounts of video and audio data, and an apparatus and method for reproducing/recording data on the high-density optical disc.

2. Description of the Related Art

In recent times, there has been newly developed a high-density optical disc capable of storing large amounts of high-quality video data and high-quality audio data, for example, a BD-RE (Blu-ray Disc Rewritable) shown in FIG. 1. Many developers have conducted intensive research into the high-density optical disc and its standardization, and it is expected that the high-density optical disc and its associated products will become increasingly popular as a recording medium.

Referring to FIG. 1, the BD-RE is comprised of a plurality of areas, for example, a clamping area, a transition area, a BCA (Burst Cutting Area), a Lead-In area, a data area, and a Lead-Out area, etc. In more detail, the clamping area, the transition area, the BCA, and the Lead-In area are sequentially located at the inner track area of the BD-RE, the data area is located at the center track area of the BD-RE, and the Lead-Out area is located at the outer track area of the BD-RE.

The Lead-In area is classified into a first guard area (Guard 1), a PIC (Permanent Information & Control data) area, a second guard area (Guard 2), an information area (Info 2), and an OPC (Optimum Power Control) area, etc. The first guard area (Guard 1) and the PIC area serve as pre-recorded areas where data has been previously stored. The remaining Lead-In area other than the first guard and PIC areas, the data area, and the Lead-Out area serve as rewritable areas where new data is rewritten.

The PIC area is adapted to store the principal information to be permanently kept on the disc, and is configured in the form of HFM (High Frequency Modulated) grooves. As shown in FIG. 2, the HFM grooves are modulated by a bi-phase modulation scheme, and store DI (Disc Information) therein.

For example, provided that only grooves having the same phase exist during a predetermined period 36T, an output value “0” is created. Otherwise, provided that grooves having different phases exist during a predetermined period 36T, an output value “1” is created.

A tracking servo for tracking the HFM grooves recorded in the PIC area uses a well-known Push/Pull method. Therefore, an optical disc apparatus includes a two-division photo-detector 12 for converting an optical signal received via an objective lens 10 and a collimator lens 11 into electrical signals Ea and Eb, and a differential amplifier 13 for differentially amplifying the electrical signals Ea and Eb generated from the two-division photo-detector 12, and outputting a tracking error signal “TE=Ea−Eb”, as shown in FIG. 3.

The optical disc apparatus performs a tracking servo operation for the HFM grooves by referring to the tracking error signal “TE=Ea−Eb” received from the differential amplifier 13. Also, the optical disc apparatus performs such a tracking servo operation for wobbled grooves recorded in the data area and the Lead-Out area by referring to the tracking error signal “TE=Ea−Eb” generated from the differential amplifier 13.

Meanwhile, a high-density read-only optical disc such as a BD-ROM (Blu-ray Disc Read Only Memory), which is now being discussed by associated companies along with the BD-RE, includes a clamping area and a Lead-In area located at its inner track area, a data area located at its center track area, and a Lead-Out area located at its outer track area, as shown in FIG. 4. In the BD-ROM, DI (Disc Information) is recorded, in the Lead-In area, in the same form of HFM grooves as in the BD-RE, and pre-pit data is recorded in the data area and the Lead-Out area in the same manner as in a CD-ROM or a DVD-ROM.

The tracking servo for the pre-pit data uses a DPD (Differential Phase Detection) method. Referring to FIG. 5, an optical disc apparatus for the DPD method includes a four-division photo-detector 22, a plurality of phase detectors 26, 27, 28, and 29, first and second sum amplifiers 23 and 24, and a differential amplifier 25. The four-division photo-detector 22 converts an optical signal received via an objective lens 20 and a collimator lens 21 into electrical signals Ea, Eb, Ec, and Ed. The phase detectors 26, 27, 28, and 29 detect individual phases of the electrical signals Ea, Eb, Ec, and Ed received from the four-division photo-detector 22. The first and second sum amplifiers 23 and 24 add the detected phase signals received from the phase detectors, and amplify the added signals. The differential amplifier 25 receives the added signals from the first and second sum amplifiers 23 and 24, and differentially amplifies the received signals.

Provided that disc information (DI) is recorded in the Lead-In area of the BD-ROM using HFM grooves in the same manner as in the BD-RE, a push/pull tracking servo used for a tracking servo of the HFM grooves and a DPD tracking servo used for a tracking servo of the pre-pit data recorded in the data area and the Lead-Out area are all required.

Provided that only HFM grooves exist in the Lead-In area and pre-pit data is not recorded in the Lead-In area, a PLL (Phase Locked Loop) operation using RF signals is unavailable, such that a data reading operation (also called a data reproducing operation) is unexpectedly discontinued in the vicinity of a connection part between the Lead-In area and the data area.

Therefore, different tracking servo operations, i.e., a push/pull tracking servo operation and a DPD tracking servo operation, must be performed on a single BD-ROM loaded in the optical disc apparatus, such that a complicated algorithm is needed to control a plurality of tracking servos and a large-sized optical disc apparatus is also needed.

### SUMMARY OF THE INVENTION

Therefore, the present invention has been made in view of the above problems, and it is an object of the present invention to provide a high-density optical disc and an apparatus and method for reproducing/recording data stored in a Lead-In area of the high-density optical disc, which record the data in the form of straight pre-pits associated with HFM grooves in the Lead-In area in order to successively perform the same tracking servo operation over the whole area of a single high-density optical disc.

In accordance with one aspect of the present invention, the above and other objects can be accomplished by the provision of a high-density read-only optical disc including a Lead-In area, a data area, and a Lead-Out area, comprising: the Lead-In area including a specific area having a straight pit-shaped line created by repeated marks and spaces, wherein either one of the mark or the space is recorded with a minimum pit length.

In accordance with another aspect of the present invention, there is provided a method for reproducing data stored in an optical recording medium, comprising the steps of: a) reading data recorded in a Lead-In area in the form of pre-pits associated with a bi-phased HFM (High Frequency Modulated) groove; and b) reproducing data recorded in a user information area by referring to the read data.

In accordance with yet another aspect of the present invention, there is provided a method for recording data in an optical recording medium, comprising the steps of: a) recording data in a Lead-In area in the form of pits associated with a bi-phased HFM (High Frequency Modulated) groove; and b) recording user data in the form of straight pits in a user information area.

In accordance with yet another aspect of the present invention, there is provided an optical recording medium, comprising: a Lead-In area in which data is recorded in the form of pre-pits associated with a bi-phased HFM (High Frequency Modulated) groove; and a user information area in which data is recorded in the form of straight pre-pits.

In accordance with yet another aspect of the present invention, there is provided an apparatus for reproducing data stored in an optical recording medium, comprising: a servo unit for reading data recorded in a Lead-In area in the form of pre-pits associated with a bi-phased HFM (High Frequency Modulated) groove, and reading data recorded in a user information area in the form of straight pre-pits by referring to the data read from the Lead-In area; and a control unit for controlling the servo unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an exemplary disc structure of a conventional BD-RE;

FIG. 2 shows HFM grooves recorded in a Lead-In area of the conventional BD-RE;

FIG. 3 is a schematic diagram of a push/pull tracking servo applied to the conventional BD-RE;

FIG. 4 shows an exemplary disc structure of a conventional BD-ROM;

FIG. 5 is a schematic diagram of a DPD tracking servo applied to a conventional optical disc apparatus;

FIG. 6 shows an exemplary disc structure of a BD-ROM in accordance with a preferred embodiment of the present invention;

FIG. 7 shows exemplary recording patterns of pits recorded in the Lead-In area of the BD-ROM in accordance with a preferred embodiment of the present invention; and

FIG. 8 is a schematic diagram of a DPD tracking servo applied to the BD-ROM in accordance with a preferred embodiment of the present invention.

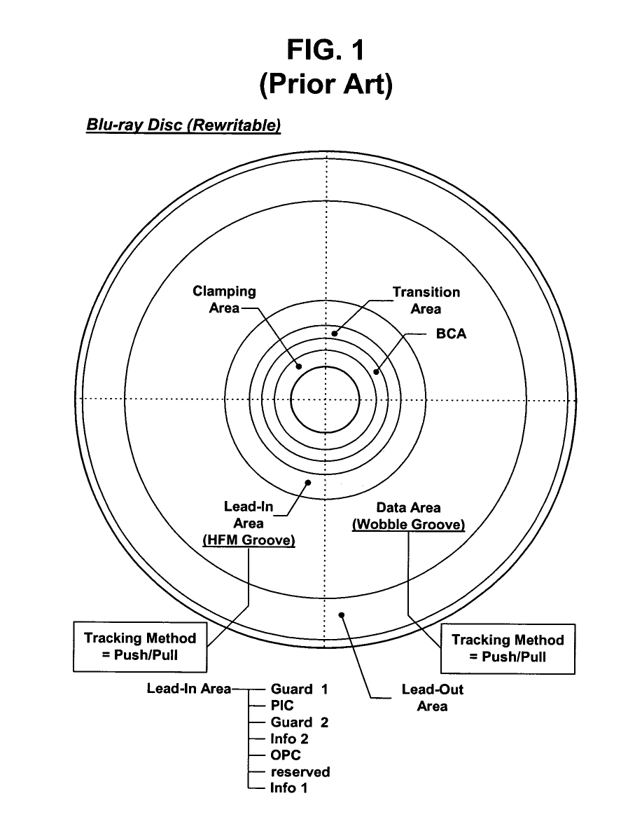

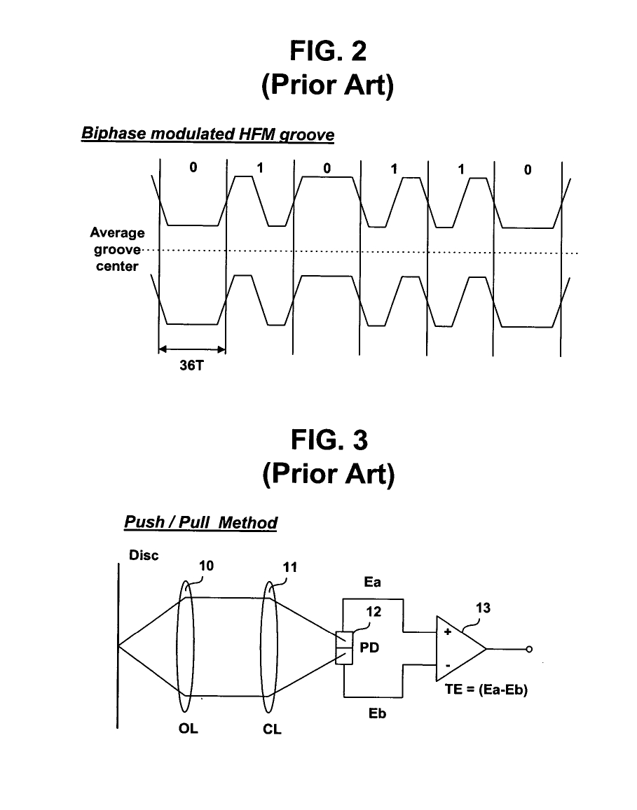

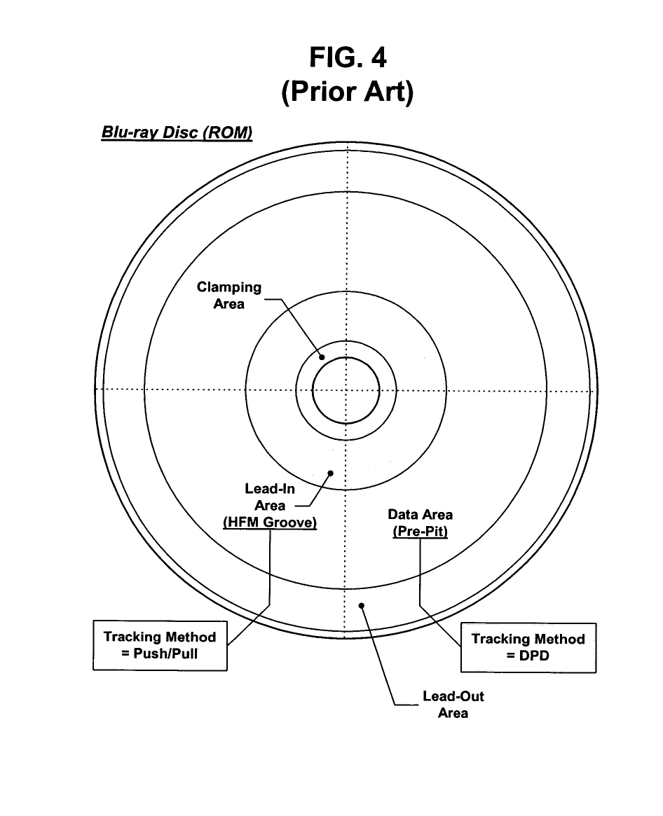

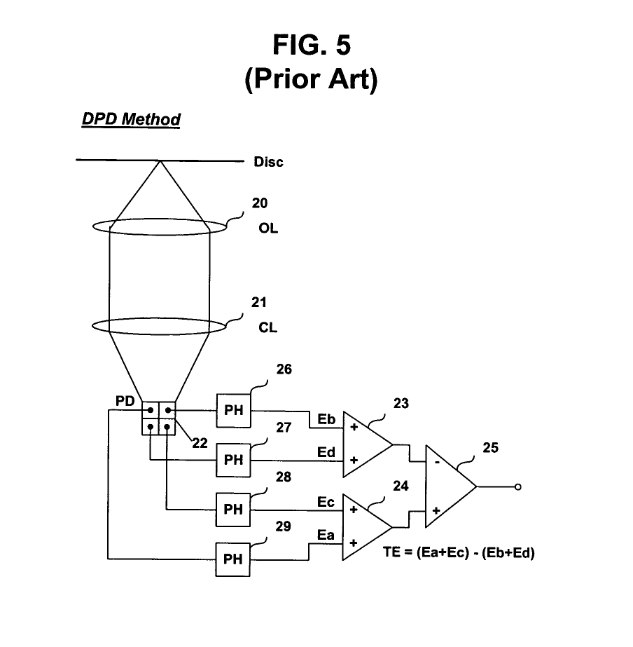

### DETAILED DESCRIPTION OF PREFERRED EMBODIMENTS

Now, preferred embodiments of the present invention will be described in detail with reference to the annexed drawings.

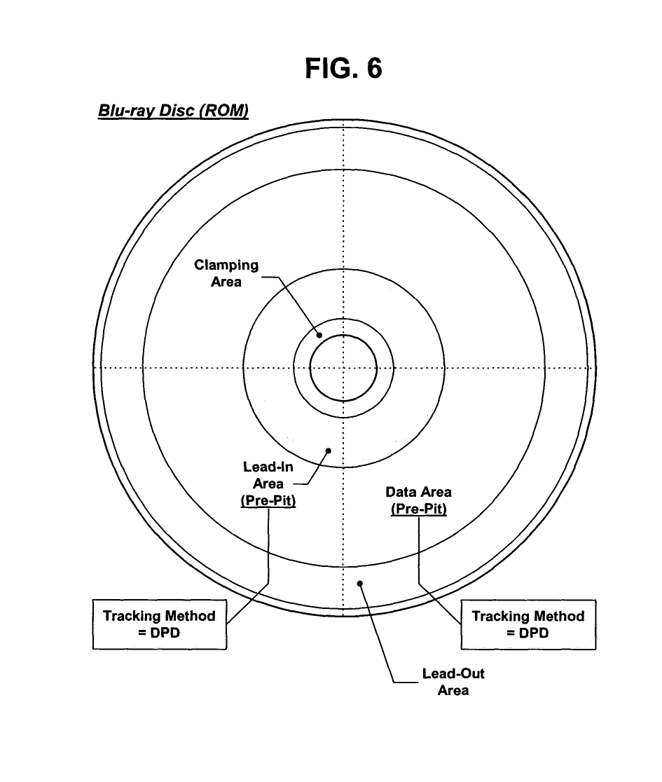

FIG. 6 shows an exemplary disc structure of a high-density read-only optical disc according to the present invention. The high-density read-only optical disc such as a BD-ROM includes a clamping area and a Lead-In area located at its inner track area, a data area located at its center track area, and a Lead-Out area located at its outer track area, as shown in FIG. 6.

Pre-pit data is stored in the data and Lead-Out areas in the same manner as in a general CD-ROM or DVD-ROM. In the BD-ROM, data is recorded in the form of straight pre-pits associated with HFM grooves in the Lead-In area, such that the same tracking servo operation can be successively performed over the whole area of a single BD-ROM. An associated detailed description will hereinafter be given.

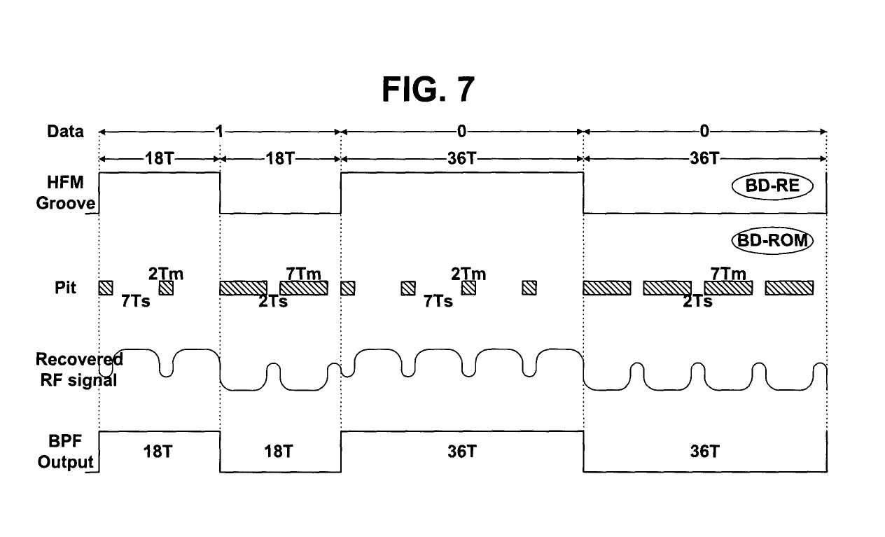

FIG. 7 shows exemplary recording patterns of pits recorded in the Lead-In area of the BD-ROM according to the present invention. For example, DI (Disc Information) permanently stored in the PIC area contained in the Lead-In area is recorded in the form of straight pits wherein a predetermined mark/space pair is repeated or a predetermined space/mark pair is repeated, as shown in FIG. 7.

A mark/space pair or a space/mark pair repeatedly recorded is recorded in the Lead-In area on the basis of bi-phase modulated HFM grooves of the BD-RE (Blu-ray Disc Rewritable). In more detail, the mark/space pair or the space/mark pair is repeatedly recorded in a period 18T or 36T having the same level, with a unique pattern corresponding to a representative data value of the period 36T.

Either one of the mark or the space is recorded with a minimum pit length 2T, such that a signal needed for a tracking servo operation can be successively detected more frequently. For example, as shown in FIG. 7, a pair of a mark 2Tm having a predetermined length 2T and a space 7Ts having a predetermined length 7T is recorded two times in a high-level period “18T” contained in a period 36T an representative data value of which is “1”. A pair of a mark 7Tm having a predetermined length 7T and a space 2Ts having a predetermined length 2T is recorded two times in a low-level period “18T” contained in the period 36T an representative data value of which is “1”.

A pair of the mark 2Tm having the length 2T and the space 7Ts having the length 7T is recorded four times in a high-level period “36T” a representative data value of which is “0”. A pair of the mark 7Tm having the length 7T and the space 2Ts having the length 2T is recorded four times in a low-level period “36T” a representative data value of which is “0”.

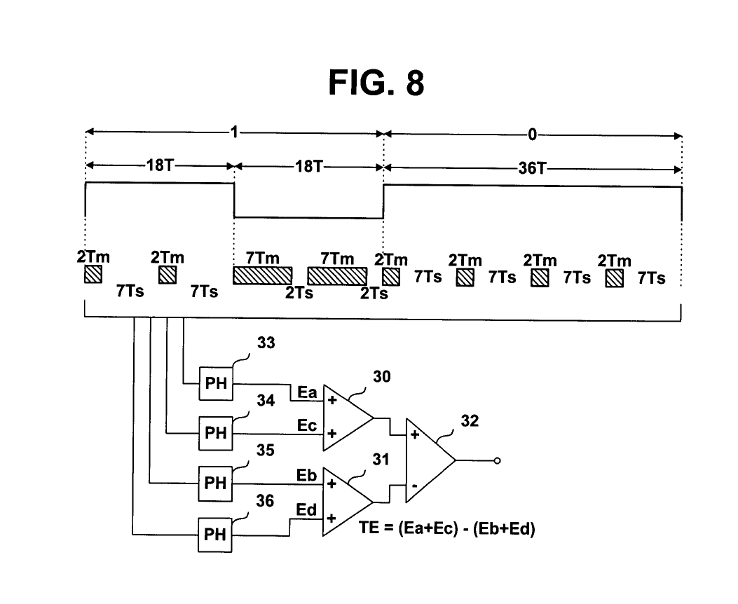

In more detail, provided that a data sequence having a predetermined value “01” is recorded in the Lead-In area, data 2Tm, 7Ts, 2Tm, and 7Ts is recorded in the high-level period “18T”, data 7Tm, 2Ts, 7Tm, and 2Ts is recorded in the low-level period “18T”, and data 2Tm, 7Ts, 2Tm, 7Ts, 2Tm, 7Ts, 2Tm, and 7Ts is then recorded in the high-level period “36T”, as shown in FIG. 8.

Therefore, the optical disc apparatus reads sampling of RF signals created by pit-shaped data of the above recording pattern, such that it can discriminate among a representative data value “0” of the high-level period “36T”, a representative data value “0” of the low-level period “36T”, and a representative data value “1” of a period 36T having different phases therein.

Meantime, the data value “0” or “1” can be represented by the other method. For example, the data value “0” can be represented by a transition from a high state to a low state in the middle of a period 36T, and the data value “1” can be represented by a transition reverse to the transition of the data value “0”. That is, the data value “1” can be expressed by a transition from a low state to a high state in the middle of a period 36T. In this case, if the data value “0” or “1” is adjacent to the same data value “0” or “1”, respectively, transitions of states (or phases) occur in the middle of a period 36T and at a boundary of 36Ts, and same states (or phases) continues only for a 18T. If the data value “0” or “1” is adjacent to the other value “1” or “0”, respectively, transitions of states do not occur at a boundary of 36T, but only in the middle of a period 36T. According to this method, DI can be also recorded in the form of straight pits wherein a predetermined mark/space pair is repeated.

The optical disc apparatus shown in FIG. 8 adapts a DPD tracking servo operation to the Lead-In area, such that the DPD tracking servo operation can be successively performed over the whole area of the BD-ROM.

For reference, the mark/space pair “2Tm/7Ts” or “7Tm/2Ts” may be replaced with a new mark/space pair “2Tm/4Ts” or “4Tm/2Ts” if needed. In this case, the pair “2Tm/4Ts” is repeatedly recorded in the high-level period “18T” three times, and the other pair “4Tm/2Ts” is repeatedly recorded in the low-level period “18T” three times. The pair “2Tm/4Ts” is repeatedly recorded in the high-level period “36T” six times, and the other pair “4Tm/2Ts” is repeatedly recorded in the low-level period “36T” six times.

Although the aforementioned embodiment of the present invention has been discussed on the basis of the BD-ROM serving as a high-density read-only optical disc, the inventive data recording pattern can be applied even to a recording-type optical disc such that the same servo operation can be made available over the whole area of the recording-type optical disc.

As apparent from the above description, the present invention provides a high-density optical disc, and an apparatus and method for reproducing/recording data stored in the high-density optical disc, such that it can efficiently prevent an algorithm for controlling a plurality of tracking servos and an apparatus for implementing the algorithm from being undesirably complicated.

Although the preferred embodiments of the present invention have been disclosed for illustrative purposes, the push/pull tracking servo and the DPD tracking servo shown in the present invention are well known to those skilled in the art, and therefore those skilled in the art will appreciate that various modifications, additions and substitutions are possible, without departing from the scope and spirit of the invention as disclosed in the accompanying claims.

What is claimed is:

1. A high-density read-only optical disc including a Lead-In area, a data area, and a Lead-Out area, comprising:
the Lead-In area including a specific area having a straight pit-shaped line created by repeated marks and spaces,
wherein either one of the mark or the space is recorded with a minimum pit length.

2. The disc as set forth in claim 1, wherein the specific area contains principal information of the high-density read-only optical disc.

3. The disc as set forth in claim 1, wherein the specific area is an area corresponding to a PIC (Permanent Information & Control data) area, contained in a Lead-In area of the high-density rewritable optical disc, for permanently storing principal disc information.

4. The disc as set forth in claim 3, wherein the high-density read-only optical disc is a BD-ROM (Blu-ray Disc ROM), and the high-density rewritable optical disc is a BD-RE (Blu-ray Disc Rewritable).

5. The disc as set forth in claim 1, wherein the mark and the space are repeatedly recorded in a predetermined recording period with different unique pit lengths according to a data value representing the recording period.

6. The disc as set forth in claim 5, wherein sum of pit lengths of each pair of the mark and the space is constant, irrespective of a representative data value of the recording period.

7. A method for reproducing data stored in an optical recording medium, comprising the steps of:
a) reading data recorded in a Lead-In area in the form of pre-pits associated with a bi-phased HFM (High Frequency Modulated) groove; and
b) reproducing data recorded in a user information area by referring to the read data.

8. The method as set forth in claim 7, wherein the pre-pits are arranged in the form of a straight line.

9. The method as set forth in one of claim 7, wherein the data recorded in the Lead-In area is read by a servo operation, and the data recorded in the user information area is read by the same servo operation as said servo operation.

10. The method as set forth in one of claim 9, wherein the servo operation is a DPD (Differential Phase Detection) method.

11. A method for recording data in an optical recording medium, comprising the steps of:
a) recording data in a Lead-In area in the form of pits associated with a bi-phased HFM (High Frequency Modulated) groove; and
b) recording user data in the form of straight pits in a user information area.

12. The method as set forth in claim 11, wherein the pits are arranged in the form of a straight line.

13. An optical recording medium, comprising:
a Lead-In area in which data is recorded in the form of pre-pits associated with a bi-phased HFM (High Frequency Modulated) groove; and
a user information area in which data is recorded in the form of straight pre-pits.

14. The medium as set forth in claim 13, wherein the pre-pits recorded in the Lead-In area are arranged in the form of a straight line.

15. The medium as set forth in claim 13, wherein the pre-pits recorded in the Lead-In area contain predetermined marks and spaces, and either one of the mark or the space is configured with a minimum pit length.

16. An apparatus for reproducing data stored in an optical recording medium, comprising:
a servo unit for reading data recorded in a Lead-In area in the form of pre-pits associated with a bi-phased HFM (High Frequency Modulated) groove, and reading data recorded in a user information area in the form of straight pre-pits by referring to the data read from the Lead-In area; and
a control unit for controlling the servo unit.
